(19) United States
(12) Patent Application Publication
(10) Pub. No.: US 2002/0038431 A1
(43) Pub. Date: Mar. 28, 2002

(54) Internet privacy system

(76) Inventors: John E.A. Chesko, Vancouver (CA); Jeff B. Chesko, North Vancouver (CA); James D. Chesko, Berkeley, CA (US)

Correspondence Address: John E. A. Chesko, 1367 Cypress Street, Vancouver, BC, V6J3L1, CA

(21) Appl. No.: 09/951,557

(22) Filed: Sep. 14, 2001

(30) Foreign Application Priority Data
Sep. 15, 2000 (CA) 2.319.871

(51) Int. Cl. G06F 11/30

(52) U.S. Cl. 713/200

(57) ABSTRACT

A method and computer program product attached to a networked client computer which increases the personal privacy and security of the networked client computer by generating random fictitious outputs concurrently or remotely with actual outputs. The outputs can be Internet searches and e-mail messages.

### FIELD OF THE INVENTION

This invention relates generally to network communication, computer programs and the Internet and, more particularly to network privacy systems.

### BACKGROUND OF THE INVENTION

The World Wide Web (also commonly known as the Internet) of computers is a large collection of computers operated under a client-server computer network model. In a client-server computer network, a client computer requests information from a server computer. In response to the request, the server computer passes the requested information to the client computer. Server computers are typically operated by large information providers, such as commercial organizations, government units and universities. Client computers are typically operated by individuals.

A continuing and important concern to individuals using the latest is their security, privacy and anonymity.

A number of techniques have been developed to track and record the actions of individuals on the Internet. These techniques track and record the searches and other information of an individual client computer. For example, server log files may compile permanent records of interaction with the client computer. Other methods have also been developed that track the activity of a client computer. For example, the use of computer “cookies” by Internet advertisers facilitates the ability of persons to compile profiles on individual computer users. For examples of such systems see U.S. Pat. Nos. 6,073,243 issued to Rosenberg et al on Jun. 6, 2000 and 6,035,332 issued to Ingassia Jr. et al on Mar. 7, 2000 which are incorporated herein by reference. The development of such sophisticated computer tracking and profiling methods has led to great concern amongst many individual computer users.

The collection and dissemination of profiling information is often done without the individual computer user's knowledge by third parties outside of the control of the individual computer user.

Concern has been raised of the ability of net advertising companies to compile personal data on individuals by merging Internet browser information with personal information data. The amalgamation of personal and Internet browsing information may permit the linking of detailed personal information with Internet browsing histories without the personal knowledge or consent of the computer user.

As well, there have been consistent reports of security holes or cookie exploits within cookie programs and other computer files that may be abused to gather unauthorized information from a computer user. An example of articles on the subject are Marron, K., “The Web's Privacy Arms Race” Globe and Mail, Mar. 8, 2001, Section T; Wood, C., “Do You Know Who's Watching You” Maclean's, Feb. 19, 2001, pp. 18-25 which are incorporated herein by reference.

In response to concerns about security and privacy on the Internet, techniques have developed that enhance the security and privacy of individuals using the Internet. Examples of these include a notification function in Internet browsers such as Netscape™ which alerts computer users when a computer cookie is placed on a user's computer and allowing a computer user to decline a computer cookie program. Some operating systems also permit the monitoring and deletion of profiling programs from a computer user's system. These methods give computer users some control over profiling information sent and received from their computer. Other security and privacy methods include encryption and anonymity methods. Shortcomings in these methods to enhance privacy include the blocking of access to computers refusing tracking information (i.e. the refusal to accept cookies blocks further searching on a particular web-page or server issuing the cookie), circumvention (i.e. tracking of URL addresses by the server computer, use of cookie exploits, etc.) or outright prohibition (i.e. illegality in some jurisdictions of high level encryption).

The concern about Internet security and privacy has also led to social and legal responses including voluntary restrictions and codes adopted by companies and persons compiling information from computer users, fuller disclosure of information collecting practices and legislated regulation. A major shortfall in these responses is that they are dependent on voluntary compliance and the international character of Internet communication blunts the ability of authorities to enforce standards and/or regulations.

In view of the foregoing, a method and program that enhances the privacy and security of computer users with respect to programs which track, profile and target users based on their Internet browsing history would be highly desirable.

### SUMMARY OF THE INVENTION

The object of the present invention is to address the above identified need by providing a method and computer program for enhanced security and privacy for individuals using the Internet by allowing individual computer users the choice of the level of security and privacy they require without having to rely on the voluntary compliance of other persons.

Accordingly, the invention relates to a method of camouflaging output requests from a browser program on a computer connected to a network of computer which includes the steps of generating one or more dummy request terms and performing one or more dummy browser requests using said terms.

In another embodiment of the invention, the dummy requests are performed together with the step of performing one or more regular browser requests using a user specified output request.

In yet another embodiment, the invention relates to a method camouflaging e-mail transmissions from an e-mail program on a computer connected to a network of computers, including the steps of generating one or more dummy e-mail messages; generating one or more dummy e-mail addresses; and sending said dummy e-mails to said addresses.

In a further embodiment, the invention relates to a computer readable memory that can be used to camouflage output activity from a computer connected to a network of computers, which includes a set of instructions, executed on said connected computer to generate a dummy output.

In a still further embodiment, the invention relates to a computer readable memory including a browser program on said connected computer and wherein the instructions include a first set of instructions for generating one or more dummy request terms; a second set of instructions for performing one or more dummy browser requests using said terms.

### BRIEF DESCRIPTION OF THE DRAWINGS

The invention is described below in greater detail with reference to the accompanying drawings, which illustrate a preferred embodiment of the invention and wherein:

FIG. 1 is a block diagram of a conventional network arrangement with a client computer connected to the Internet via a server computer;

FIG. 2 is a flow chart generally summarizing steps of browser operation between a client computer and a server computer;

FIG. 3 is a flow chart generally summarizing the method steps according to the present invention;

FIG. 4 is a flow chart of method steps according to the invention in which search terms are randomly generated in parallel with actual search terms; and

FIG. 5 is a flow chart of method steps according to the present invention in which search terms are randomly generated in parallel with the selection of actual search terms.

### DETAILED DESCRIPTION OF THE PREFERRED EMBODIMENTS

Browser Embodiment

In one embodiment of the present invention, a computer program, sometimes referred to herein as the “chaff” program is attached to a client computer's Internet browser program and enhances the personal privacy and security of the client computer by generating random fictitious or dummy Internet web search outputs concurrently with actual or regular search outputs to server computers to “camouflage” the actual web searches being conducted. An “actual” or “regular” search refers to a search which is one that the user performs in the normal course. The fictitious or dummy searches are ones which the user has no interest in performing in the normal course. The randomly conducted searches are indistinguishable in format from actual searches thereby adding a variable of uncertainty to the output and increasing the complexity of surveillance for an organization or person attempting to track the searches performed by a client computer.

The program of the present invention is integrated with the individual's web browser (or at the initial server where search browsing occurs at that point) and works concurrently with it. It will be appreciated that the program of the present invention can be programmed in any number of suitable computer languages including the language of the particular browser used by the client computer. The invention may be a separate program working in tandem with the browser program or incorporated into the browser program. When an individual performs a search using their web browser, the program randomly-generates one or more fictitious searches according to the same protocol as the original search using randomly-generated terms/parameters. The output of the randomly-generated and the actual search to the server computer is in the same protocol format (with the exception of the content of the search) as the actual or regular search. Therefore, from the perspective of the web server, the randomly-generated output is indistinguishable in form from the actual search output. Profiling techniques such as web cookies and search records are unable to distinguish actual from randomly-generated searches which result in server log files containing both types intermingled.

The user of the program will be able to customize the operation of the program in a number of ways. Parameters for the random generation of search terms may be customized by the user. A number of random-generation methods may be used including:

i) complete random URL or IP address generation (alpha-numeric);

ii) random selection from an electronic dictionary, group of objects or other set parameters;

iii) random selection of previously viewed (fictitious or actual) URL or IP addresses; and

iv) any combination of the above

Random generation may be alpha-numeric (a randomly-generated word, domain name or URL) or sequential (such as based on random quadrant of the search monitor or an arbitrary number such as the 3rd or 4th choice on a hit list). The parameters used can include length of domain name, Internet address, and search type topics. For example, if the user is performing actual Internet searches in a particular field, such as engineering, the dummy searches can be limited by the parameters chosen to only do dummy searches of engineering web sites.

The order in which actual and fictitious searches are sent to the server are randomized so there is no distinguishable pattern.

Customization settings and options may also be set to mimic the browsing habits of the user. The parallel search method (each search or initiation will generate one or more fictitious searches) will closely mirror the browsing habits of the user. A “learning” program that adapts the fictitious search according to browsing habits of the user (such as the length of terms searched, time delay between searches, etc.) using a feedback loop that automatically customizes the program may be included.

The program may also be configured to initiate fictitious searches automatically when the individual user is not performing an actual search. Tracking data which includes time and place of use information is therefore camouflaged, increasing privacy to the individual user.

The program also gives individuals the option of customizing the degree of security provided (such as each actual search may initiate from one to many fictitious searches depending on the degree of privacy and security desired by the user).

The randomly-generated search request outputs are initiated by the program concurrently with actual search requests generated by the user of the client computer. The program may also be configured to generate random search request outputs at times, which could be pre-set or random, when a user is not using their computer. The randomly-generated search request outputs adhere to the same protocol format as actual search request outputs and are therefore unidentifiable as randomly-generated search request outputs from the perspective of the server computer receiving the search request outputs. Profiling data based on search request outputs from the client computer (both randomly-generated and actual) will contain indistinguishable randomly-generated and actual data.

The functional components of the system include an algorithm for randomly generating and storing search terms, URL or IP addresses with properties which include authenticity so that they are indistinguishable from actual search terms and Internet sites visited, history disk file, and user diagnostics for monitoring the I/O operations and adjusting the random generation of search request outputs. The method for generating random search request outputs may involve look-up tables interfacing with multiple Internet search engines, recursive techniques for making address lists, the use of a random number generator, etc.

The program activated preferably automatically upon initiation of a web session by the launching of the user's web browser or other methodology. When the browser program is originally launched and connected to the Internet, a parallel session will be automatically launched which generates fictitious search and look-up requests which are interspersed among the actual search and look-up requests sent to the server computer through the client computer browser. Consequently, the permanent browser history (written to disk log files) of web site requests and other profiling data will include both fictitious and actual data. The algorithm which generates fictitious search requests may be generated using a list of old cookies, new cookies, web site requests generated by search engines, random number generators, dictionary terms, look up tables, parsed phrases, etc. The functional operation of this ‘shadow’ session will make it indistinguishable from the user's actual interactions and browsing preferences while operating a web session. The program may optionally run diagnostics to allow the user to monitor I/O operations into the relevant files. The user may customize the configuration of the program to vary the number and characteristics of fictitious outputs based upon requirements of privacy, data throughput and browser speed for the actual session while allowing the background (fictitious or dummy) session to successfully generate requests.

E-mail Program Embodiment

In another embodiment of the invention, a computer program according to the present invention is attached to a client computer's Internet e-mail program and enhances the personal privacy and security of the client computer by generating random fictitious e-mail outputs concurrently with actual e-mail outputs.

The program enhances the security and privacy of individual computer uses by generating random encrypted e-mail messages which are sent interspersed with actual encrypted e-mail messages. Randomly-generated encrypted e-mail messages will be indistinguishable in format from actual encrypted e-mail messages so that an unauthorized organization or person intercepting and attempting to decipher the client computer's e-mail messages will not be able to distinguish actual e-mail messages from the randomly-generated e-mail messages searches generated by the program. The increased complexity of deciphering both actual and fictitious encrypted e-mail messages will give the user of the invention an increased level of security and privacy with encrypted e-mail communications.

The program is integrated with the individual's encrypted e-mail program. When an individual generates an encrypted e-mail using their e-mail program, the program randomly-generates a fictitious encrypted e-mail using randomly-generated terms/parameters. The output of the randomly-generated and the actual e-mail to an unauthorized interceptor would be in the same protocol format (with the exception of the content of the e-mail and possibly the encryption method) as the actual e-mail. Therefore, from the perspective of the unauthorized interceptor, the randomly-generated output would be indistinguishable in format from the actual e-mail output. Deciphering techniques would be unable to distinguish actual from randomly-generated e-mails and intercepted e-mails would contain both types intermingled.

The user of the program or method is able to customize the operation of the program in a number of ways. Parameters for the random generation of encrypted e-mails may be customized by the user. E-mail content, address and encryption method, or a combination of these, can be randomly generated. A number of random-generation methods may be used including:

i) complete random generation (alpha-numeric),

ii) random selection from a dictionary, electronic address book or other set parameters;

iii) random generation of various encryption methodologies, and

iii) any combination of the above.

The order in which actual and fictitious encrypted e-mails are outputted will also be randomized so there is no distinguishable pattern.

The program may also be configured to operate automatically to send fictitious encrypted e-mails at any time, whether or not a user is using their computer. Recipient addresses may be randomly generated or preselected by the user of the program. Tracking data which includes time and place of use information is therefore camouflaged, increasing privacy to the individual user.

Customization options may also be set to mimic the e-mail habits of the user. Each parallel e-mail session (each e-mail or initiation will generate one or more fictitious e-mails) will closely mirror the habits of the user.

The program also gives individuals the option of customizing the degree of security provided (i.e. each actual e-mail may initiate from one to many fictitious e-mails depending on the degree of privacy and security desired by the user).

The program is integrated into the user's e-mail program. When the user initiates an e-mail, the program generates fictitious e-mails that are interspersed randomly with actual e-mails outputted by the client computer. Output from the client computer is indistinguishable for both actual and fictitious e-mails so that intercepting methodologies are not able to distinguish actual and fictitious e-mails and unauthorized deciphering would be complex.

When the e-mail program is originally launched, a parallel session will be automatically launched which generates fictitious e-mail outputs that are interspersed among the actual e-mail outputs. Consequently, intercepted e-mail outputs will include both fictitious and actual data. The functional operation of this ‘shadow’ session will make it indistinguishable from the user's actual e-mail output. The program runs diagnostics and allows the user to monitor I/O operations into the relevant files and the user may customize the configuration of the program to vary the number and characteristics of fictitious e-mail generation based on requirements of privacy, data throughput, communication speed, while allowing the background (fictitious or dummy) session to successfully operate.

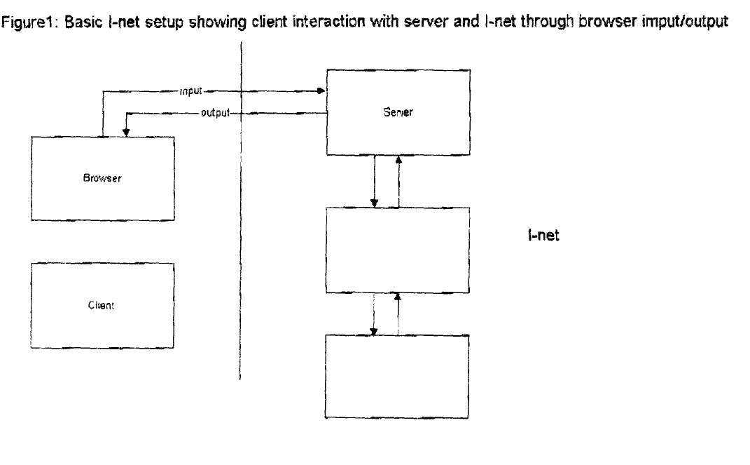

FIG. 1 illustrates a conventional network arrangement of a client computer connected to a server which is networked to other server computers forming the Internet. All information relating to search requests runs through the client computer browser such as Netscape™ running on the client computer.

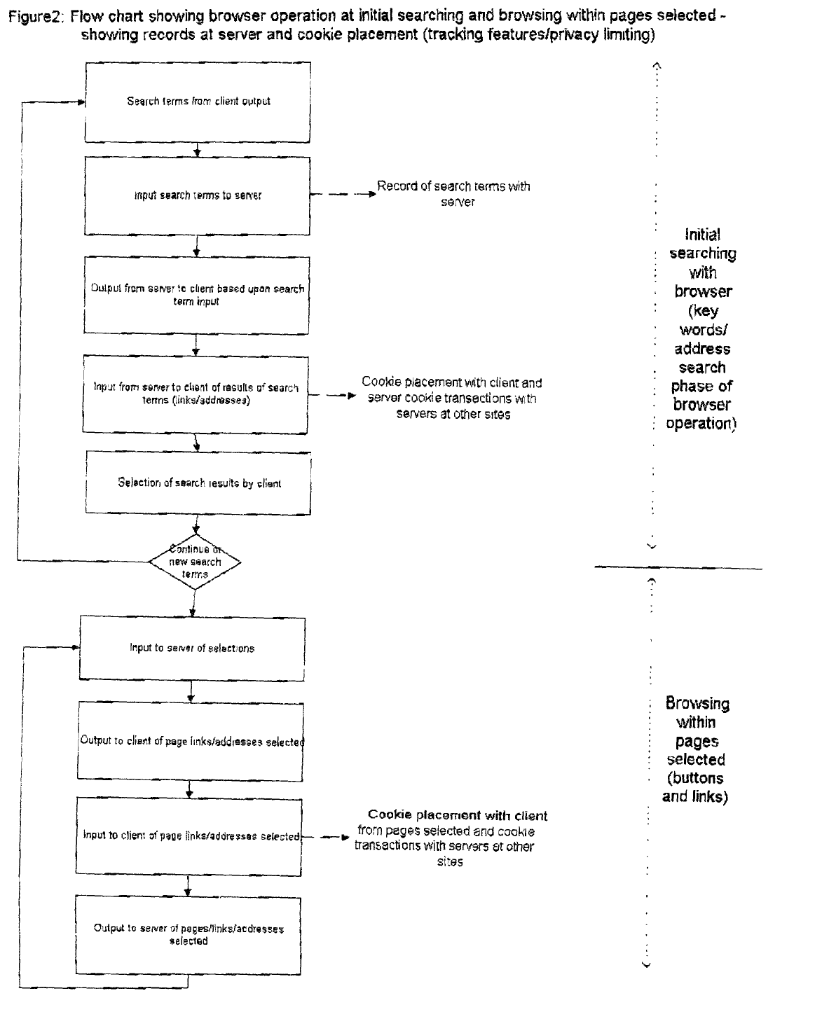

FIG. 2 illustrates in more detail conventional browser operation and interaction between a client computer and a server computer and shows the collection of information which may be used for tracing purposes. Search terms such as a request for a specific website page originate with the client computer and are outputted to the server computer. The server log file compiles a record of the search requests outputted from the client computer to the server computer. The server, in network with other server computers on the Internet, executes the search request sent by the client computer and outputs the result of the search request to the client computer. At this point, tracking programs such as cookie programs, may be placed on the client computer hard drive. The client computer may select from the search terms received from the server computer such as choosing a link on a received web page or may initiate a new search with new or revised search terms. Where the client computer selects from the search options received from the server computer in response to the selections received from the server computer, these are inputted to the server computer and the server routes the requested selections to the client computer. Again, profiling information is collected at the server log files and with the placement of cookie programs with the client computer.

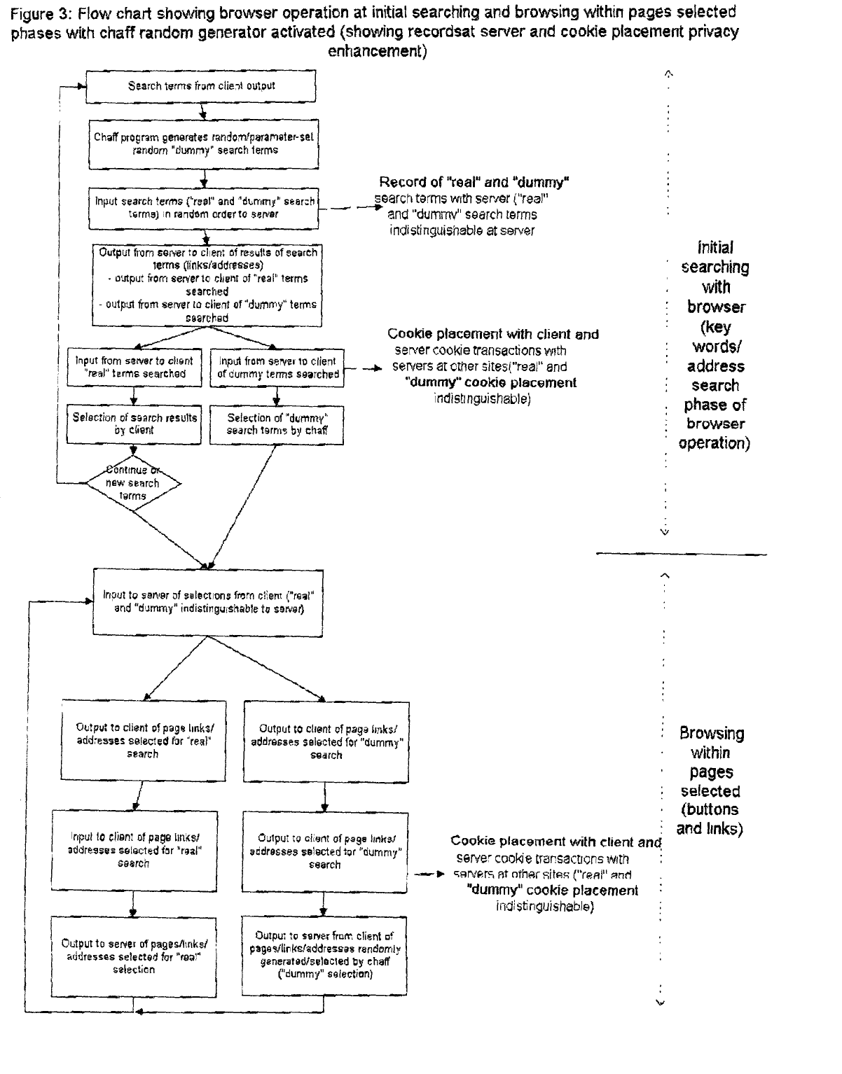

Referring to FIG. 3, the method steps of browser operation with the invention implemented includes as in the conventional browser operation of FIG. 2, search terms being originated with the client computer. Random fictitious search terms are then generated in accordance with the parameters (such as number of fictitious searches, method of random search generation, etc.) set by the user and outputted along with the actual search term to the server computer in random order. As the randomly-generated search terms are formatted in the identical protocol format as the actual search terms, the randomly-generated search terms and the actual search terms are indistinguishable in format at the server computer. The server log file compiles a record of the search requests (both randomly-generated and actual) outputted from the client computer to the server computer. The server, in network with other server computers on the Internet, executes the search request sent by the client computer and outputs the result of the search request to the client computer. At this point, tracking programs such as cookie programs, may be placed on the client computer hard drive from both randomly-generated search requests and the actual search request. The client computer may select from the search terms received from the server computer or may initiate a new search with new or revised search terms. Where the client computer selects from the search options received from the server computer in response to the selections received firm the server computer, the invention will also randomly select from the selections received from the fictitious search. These (selections from the actual and the fictitious search) are inputted to the server computer and the server routes the requested selections, again both actual and fictitious, to the client computer. Again, profiling information is collected at the server log files and with the placement of cookie programs with the client computer.

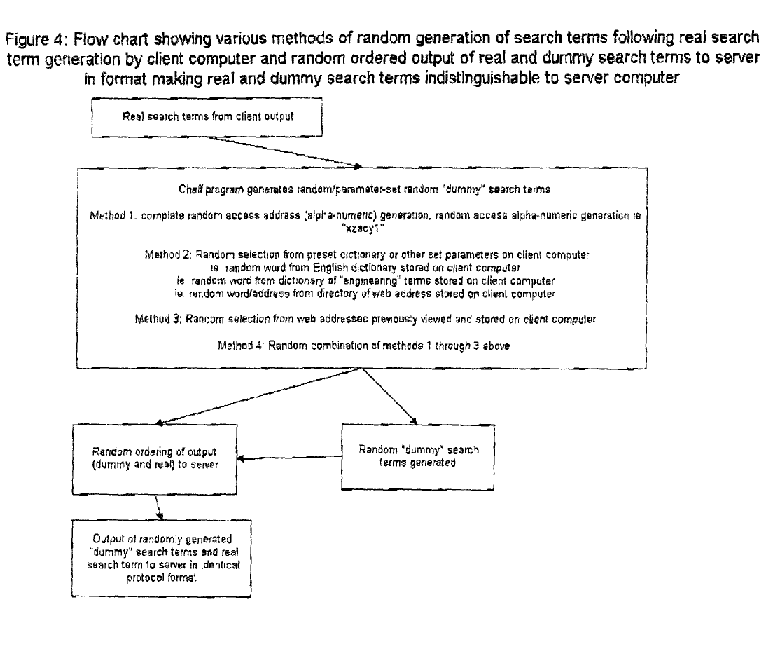

FIG. 4 illustrates in more detail the random generation of search terms in parallel with actual search terms and the random output of actual and randomly-generated search terms to the server. Following the formulation of an actual search from the client computer, the chaff (TM) program generates random search terms according to one of the following methods or a combination thereof. Method 1 utilizes random generation of alpha-numeric terms, for example, random characters of the same length as the actual search term. Method 2 generates random search terms from a pre-selected data-base of possible search terms that has been pre-selected by the client computer user. For example, the chaff program may randomly select a term from a dictionary of many possible terms or a web-site address from a data-base of possible addresses. In method 3, web addresses for the fictitious searches are selected from a database of previously viewed web addresses on the client computer. Both the actual and randomly-generated search term(s) are then outputted to the server computer in random order.

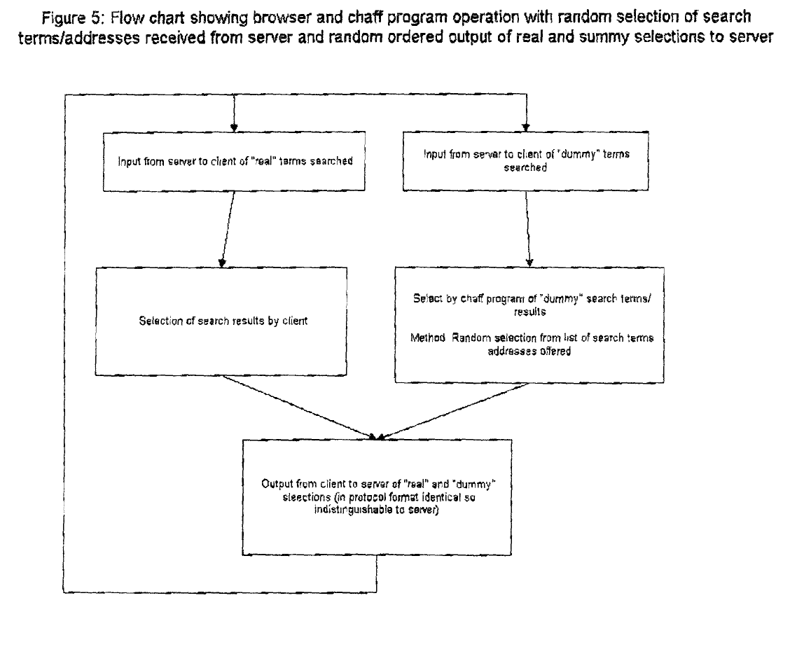

FIG. 5 illustrates the selection of search terms from selections outputted from the server in response to search terms from the initial client computer search. Following initial search term input to the server computer of actual and fictitious search terms by the client computer, the server returns selections to the client computer based on the results of the search procedure conducted by the server computer. The input of the results of the search conducted by the server are outputted to the client computer. Both the results from the actual search and the fictitious search are outputted to the client computer. The client computer user may select from the search results. Following the selection from the actual search results by the client computer, the invention randomly selects from the fictitious search results (or a fictitious selection from the actual search results). The actual and fictitious selection(s) from the search results are randomly outputted to the server in protocol format such that, from the perspective of the server computer, the actual and fictitious selections are indistinguishable.

The method and program is also useful in the generation of concurrent fictitious outputs in other embodiments not described herein. For example, the method and program of generating random fictitious data concurrently with actual data for purposes of enhancing security and privacy on the Internet will also be applicable to other operations and/or protocols (such as file transfers, data-base queries, web-crawler applications, firewalls etc.).

It will be appreciated that the e-mail embodiment described above would follow similar steps as the ones described and illustrated in the drawings.

1. A method of camouflaging output requests from a browser program on a computer connected to a network of computer comprising the steps of:
generating one or more dummy request terms; and,
performing one or more dummy browser requests using said terms.

2. A method according to claim 1, including the step of performing one or more regular browser requests using a user specified output request;

3. A method according to claim 2, wherein said dummy requests uses the same protocol as said regular browser request.

4. A method according to claim 3, wherein said requests are Web search requests.

5. A method according to claim 4, wherein said dummy request terms is randomly generated.

6. A method according to claim 4, wherein generating said dummy request terms includes the step of selecting a term from a group comprising a dictionary and group of objects.

7. A method according to claim 4, wherein generating said dummy request term includes the step of selecting a web addresses from a directory of web addresses.

8. A method of camouflaging e-mail transmissions from an e-mail program on a computer connected to a network of computers, comprising the steps of:
generating one or more dummy e-mail messages;
generating one or more dummy e-mail addresses; and,
sending said dummy e-mails to said addresses.

9. A method according to claim 8, including the step of sending a regular user prepared e-mail;

10. A method according to claim 9, wherein generating said dummy e-mails includes the step of generating dummy e-mail content.

11. A method according to claim 8, including the step of selecting a said addesses from a directory of e-mail addresses.

12. A computer readable memory that can be used to camouflage output activity from a computer connected to a network of computers, comprising:
a set of instructions, executed on said connected computer to generate a dummy output.

13. A computer readable memory according to claim 12, including a browser program on said connected computer and wherein said instructions include a first set of instructions for generating one or more dummy request terms;
a second set of instructions for performing one or more dummy browser requests using said terms.

14. A computer readable memory according to claim 12, wherein said instructions include a second set of instructions for generating a dummy output automatically.

15. A computer readable memory according to claim 12, wherein said instructions include a third set of instructions for simulating the normal output activity of said computer whereby use habits of a user of said computer are mimiced.

16. A computer readable memory according to claim 12, including an e-mail program program on said connected computer and wherein said instructions include a first set of instructions for generating one or more dummy e-mails.
